(19) United States
(12) Patent Application Publication
(10) Pub. No.: US 2003/0055958 A1
(43) Pub. Date: Mar. 20, 2003

(54) Method for automatically creating network printer ports on a workstation

(76) Inventors: Richard Francis Russell, Lexington, KY (US); Thomas Elmer Samples, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 09/960,470

(22) Filed: Sep. 20, 2001

(51) Int. Cl. G06F 15/16; G06F 15/173

(52) U.S. Cl. 709/224; 709/245; 709/250

(57) ABSTRACT

A method of creating network printer ports on a computer workstation includes the steps of providing a network; communicatively coupling the computer workstation to the network; and communicatively coupling at least one printer to the network. The computer workstation performs the steps of transmitting a discovery packet to which a first printer of a designated type can respond; receiving a response packet from the first printer, the response packet including printer-specific network information of the first printer; identifying whether a network port exists for the first printer; and if no such network port exists, then creating a first network printer port for the first printer based on the printer-specific network information for the first printer.

### BACKGROUND OF THE INVENTION

1. Field of the Invention

The present invention relates to the creation of printer ports on a workstation and, more particularly, to automatically creating a network printer port on a computer workstation.

2. Description of the Related Art

With the large number of network devices, such as printers, which can be connected to a computer network, various methods have been developed to identify and manage network devices enabling them to communicate. Typically, a network directory service, which is essentially a catalog or directory of names and addresses of network devices, is maintained on selected network devices. Devices within a local area network (LAN) usually have their own route tables of other devices in the LAN to allow quick and efficient communication within the LAN.

Each device that receives, sends and/or routes information between or among other devices on a LAN is initialized to communicate with other devices using a communication protocol that may be understood by the other devices. One such communication protocol used by these devices is a transmission control protocol/internet protocol (TCP/IP). Each device that can send or receive information (e.g., a host device) must also have a unique host address. The type of host address used on a LAN that uses TCP/IP, is commonly referred to as an Internet protocol (IP) address. A standard TCP/IP address is 4 bytes (32 bits) in length, providing a total of 2³² possible IP addresses. Those of ordinary skill in the art will readily recognize that not all of these possible IP addresses are available due to administrative expediencies, such as reserving blocks of IP addresses for future use.

IP addresses may be dynamically allocated by having a pool of IP addresses, such as an IP address pool, from which to draw each time an IP address is needed. Once a device connects to a network and is properly authenticated, an IP address is allocated for use by the device. This task is normally performed by a Dynamic Host Configuration Protocol (DHCP) server existing on the LAN.

In order for a computer workstation to communicate with a network printer, a network printer port must be created on the workstation. It is typical for such a task to be performed manually using both the graphical user interface (GUI) of the operating system, such as a Windows® operating system, and the GUI of third party port monitor software. Such a process, however, can be very confusing and frustrating to a user who is not particularly well versed in computer technology. For example, the user must first know to create the network printer port on the workstation. Then, the user must step through a multitude of dialog screens, some of which require technical information that is not familiar to many users.

For example, the user begins the tedious task of manual network printer port creation through the “PROPERTIES” dialogs in a Windows printer GUI, and eventually uses the GUI associated with the third party port monitor software. To be successful in creating the network port, the user must know and provide the technical information associated with the networked printer, and in particular, the printer's machine access code (MAC) address and/or the printer's TCP/IP address. Thus, many users find the process of creating a network printer port on a workstation to be source of significant confusion and frustration.

What is needed in the art is a method that automatically creates a network printer port on a computer workstation.

### SUMMARY OF THE INVENTION

The present invention provides a method that automatically creates a network printer port on a computer workstation.

In one form thereof, the present invention includes the steps of providing a network; communicatively coupling the computer workstation to the network; and communicatively coupling at least one printer to the network. The computer workstation performs the steps of transmitting a discovery packet to which a first printer of a designated type can respond; receiving a response packet from the first printer, the response packet including printer-specific network information of the first printer; identifying whether a network port exists for the first printer; and if no such network port exists, then creating a first network printer port for the first printer based on the printer-specific network information for the first printer.

In another form thereof, the present invention is directed to a computer program for automatically creating network printer ports on a computer workstation coupled to a network. The computer program includes instructions for performing the steps of transmitting a discovery packet to which a printer of a designated type coupled to the network can respond; receiving a response packet from the printer thereby identifying the printer as being of the designated type, the response packet including printer-specific network information of the printer; identifying whether a network port exists on the computer workstation for the printer; and if no such network port exists, then, creating a first network printer port for the printer based on the printer-specific network information for the printer.

In still another form thereof, the present invention is directed to a method of automatically creating a network printer port on a workstation connected to a network, including the steps of providing a Windows operating system at the workstation, the Windows operating system including a print subsystem; providing a Windows print spooler at the workstation having an Add Port mechanism; providing a port monitor at the workstation; and invoking the Windows print spooler to initialize the port monitor. Upon initialization of the port monitor, the port monitor sends a propriety broadcast message to which each printer of a designated type on the network can respond. Each printer of the designated type responds to the broadcast with a unique data packet including printer-specific network information. The port monitor receives the printer-specific network information, and for each identified printer of the designated type for which no port exists, the port monitor invokes the Add Port mechanism of the Windows print spooler. Thereafter, the port monitor passes the printer-specific network information to the Windows print spooler for creation of the network printer port on the workstation.

An advantage of the present invention is that a network printer port is created automatically, without user interaction.

Another advantage of the present invention is that the network printer port is created “silently”, without the user even knowing that the network printer port was created.

Still another advantage of the present invention is that it simplifies network printer port creation for a user, whereby the user need not possess technical information relating to a networked printer in order to create the network printer port.

Another advantage is that the process of the present invention is fast enough that it can be executed at any time without adversely affecting the workflow of a computer workstation.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic block diagram of a computer workstation in a networked environment and embodying the present invention; and

FIG. 2 shows a flow diagram of a process for automatically creating a network printer port on the workstation of FIG. 1 in accordance with the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

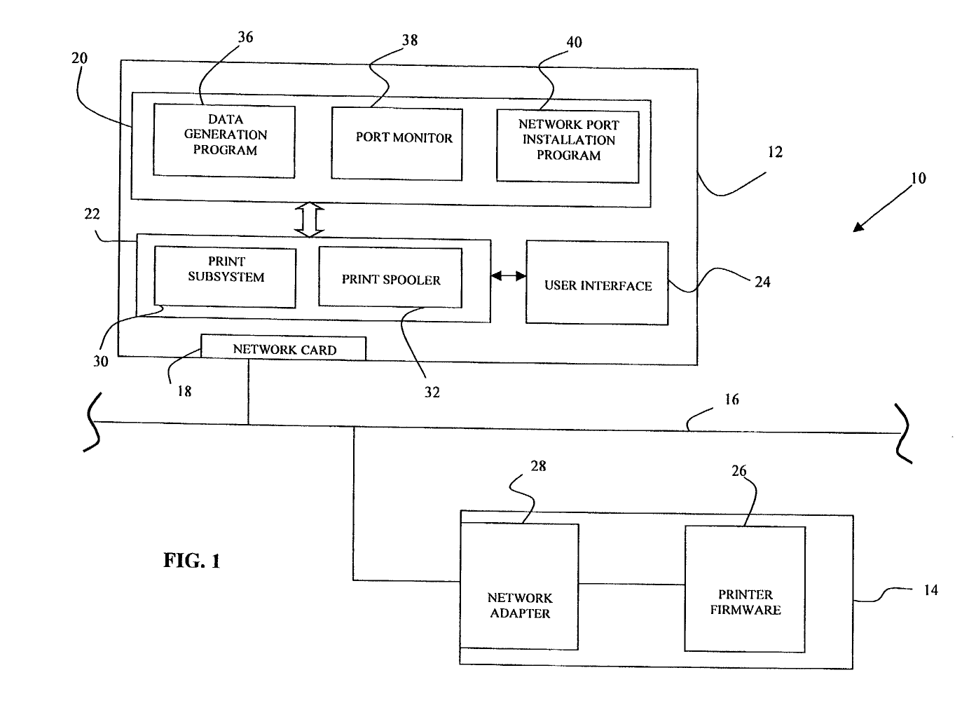

Referring now to the drawings and particularly to FIG. 1, there is shown networked imaging system 10 that includes a computer workstation 12, a networked printer 14 and a network 16.

Computer workstation 12 includes at least one microprocessor, random access memory (RAM), read only memory (ROM) and various serial and parallel port connections, of a type well known in the art. Computer workstation 12 also includes a network card 18, such as an Ethernet card, for providing a physical connection to network 16. Computer workstation 12 is configured with software, graphically depicted in FIG. 1, including a printer driver 20 and an operating system 22.

In addition, computer workstation 12 includes a user interface 24 that permits user interaction via a CRT monitor and an input device, such as a keyboard and/or a mouse. User interface 24 includes graphical user interface software that allows a user to display information relative to networked printer 14, and to manually assign IP addresses to devices connected to network 16, where automatic address assignment is not feasible.

Networked printer 14 may be an imaging device, such as a Lexmark® ink jet printer. Networked printer 14 includes printer firmware 26 and a network adapter 28, which are communicatively interconnected. All network traffic directed to networked printer 14 flows through network adapter 28 to printer firmware 26. Printer firmware 26 is responsible for generating a printed page on networked printer 14, and printer firmware 26 relies on network adapter 28 to deliver printer control information and print data thereto. For purposes of the present invention, it is presumed that network adapter 28 is configured to communicate via network 16. Network adapter 28 may be implemented as an application specific integrated circuit (ASIC), and may be a basic low-cost network adapter (LCNA) available from Lexmark International, Inc.

Network 16, such as a local area network (LAN), provides communicative interconnection between computer workstation 12 and networked printer 14, and other devices adapted for network connection to network 16. Network 16 is not connected to the Internet; however, those skilled in the art will recognize that computer workstation 12 may be adapted for Internet connection via a modem.

In the embodiment described herein, operating system 22 is preferably a Windows® operating system, such as Windows 98 or Windows 2000, available from Microsoft Corporation of Redmond, Wash., U.S.A. The specifications of these operating systems are readily available, and are incorporated herein by reference. Operating system 22 includes a print subsystem 30, such as a Windows print subsystem, and a print spooler 32, such as a Windows print spooler.

Printer driver 20 includes a data generation program 36, a port monitor 38 and a network port installation program 40. Data generation program 36 generates data formatted to be sent to networked printer 14. Port monitor 38 contains the computer instructions used for acquiring the information necessary for the automatic creation of a network printer port, without user interaction, for association with a networked printer, such as networked printer 14. Network port installation program 40 includes the supervisory instructions for invoking port monitor 38 and print spooler 32 for effecting the automatic creation of a network printer port on a computer workstation, e.g., computer workstation 12, on which printer driver 20 is installed.

Print spooler 32 is responsible for loading and initializing port monitor 38 when print subsystem 30 is loaded. In general, print spooler 32 is a program that allows a user to complete other computer workstation tasks during a printing process. However, in addition, print spooler 32 has an Add Port mechanism, which in essence is a program that calls an Add Port application programming interface (API) in port monitor 38. The Add Port API includes a set of standard software interrupts, calls, data formats and routines that print spooler 32 uses in adding a network printer port to computer workstation 12.

Port monitor 38 performs network printer discovery. In the discovery process, which will be described in more detail below, port monitor 38 identifies all networked devices on network 16 that can respond to a transmitted proprietary discovery packet. Associated with the identified networked devices are the machine address code (MAC) and an IP address for each discovered networked printer. For example, network adapter 28 of networked printer 14, being configured, will include both a unique MAC address and a valid IP address. The MAC address and IP address assigned to network adapter 28 allows printer driver 20 to address and communicate with network adapter 28.

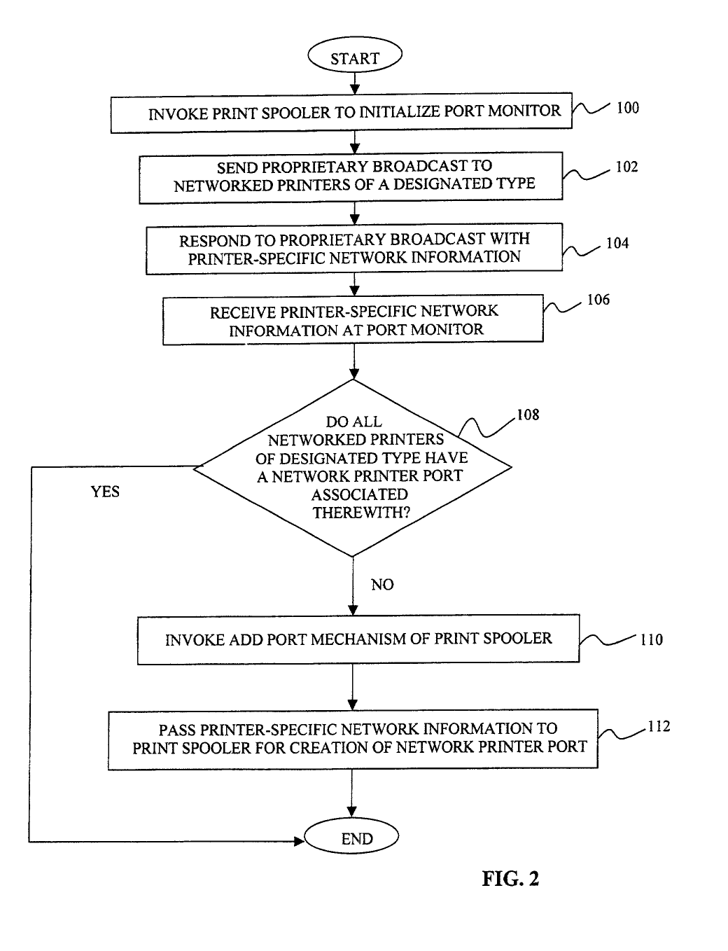

Now additionally referring to FIG. 2, there is depicted a plurality of processing steps associated with a method of automatically creating a network printer port on computer workstation 12 connected to network 16. In the embodiment described herein, the process steps depicted in FIG. 2 are performed under the control of network port installation program 40, which resides in printer driver 20 loaded on computer workstation 12.

At step 100, when print subsystem 30 is loaded by computer workstation 12, print spooler 32 is invoked to initialize port monitor 38. Print subsystem 30 is loaded, for example, at the start-up of computer workstation 12, or upon a power-on reset.

At step 102, upon initialization of port monitor 38, port monitor 38 sends a propriety broadcast message to which each networked printer of a designated type, such as networked Lexmark® ink jet printer, on network 16 can respond. For purposes of this example, networked printer 14 is configured as a printer of the designated type.

At step 104, each networked printer of the designated type, such as networked printer 14, responds to the proprietary broadcast message with a unique data packet including printer-specific network information. The printer-specific network information includes a TCP/IP address and a MAC address of each networked printer of the designated type. In the case of networked printer 14, network adapter 28 provides the TCP/IP address and MAC address that were previously stored in network adapter 28.

At step 106, port monitor 38 receives the printer-specific network information, and thus, each printer of the designated type is identified. In the case of networked printer 14, port monitor 38 receives the TCP/IP address and MAC address of networked printer 14 from network adapter 28.

At step 108, it is determined whether any networked printer of the designated type does not include a network printer port associated therewith on computer workstation 12. In the event that all identified networked printers of the designated type have an associated network printer port, the process of FIG. 2 terminates.

However, for each identified networked printer of the designated type for which no network printer port exists, the process proceeds to step 110, wherein port monitor 38 invokes the Add Port mechanism of print spooler 32. In turn, print spooler 32 invokes the Add Port API of port monitor 38. Thus, assuming that no network printer port presently exists for networked printer 14, port monitor 38 invokes the Add Port mechanism of print spooler 32, which in turn invokes the Add Port API of port monitor 38 as a prerequisite to establishing a new network printer port in computer workstation 12 for networked printer 14.

Thereafter, at step 112, port monitor 38 passes the printer-specific network information to print spooler 32 for creation of a unique network printer port for each identified networked printer of the designated type for which no network printer port previously existed. In the case of networked printer 14, port monitor 38 passes the TCP/IP address and a MAC address of networked printer 14 to print spooler 32 for creation of a unique network printer port on computer workstation 12 corresponding to networked printer 14.

As a result of the process of the present invention, a network printer port is established automatically on computer workstation 12 without requiring interaction with the user.

In the embodiment of the present invention described above, the process of FIG. 2 is started when print subsystem 30 is loaded by computer workstation 12. However, it is contemplated that the process of FIG. 2 can be performed at other times, such as, for example, at some time prior to attempting to send a print job to a networked printer, or on a periodic basis.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of creating network printer ports on a computer workstation, said computer workstation having an operating system that includes a print subsystem, comprising the steps of:
providing a network;
communicatively coupling said computer workstation to said network;
communicatively coupling at least one printer to said network;
said computer workstation performing the steps of:
transmitting a discovery packet to which a first printer of a designated type can respond;
receiving a response packet from said first printer, said response packet including printer-specific network information of said first printer;
identifying whether a network port exists for said first printer; and
if no such network port exists, then creating a first network printer port for said first printer based on said printer-specific network information for said first printer.

2. The method of claim 1, further comprising the steps of initializing a port monitor upon a loading of said print subsystem, said port monitor performing each of said transmitting step, said receiving step and said identifying step.

3. The method of claim 2, wherein said operating system is a Windows operating system.

4. The method of claim 3, wherein said Windows operating system includes a print spooler for initializing said port monitor and for performing said creating step.

5. The method of claim 4, wherein said print spooler receives said printer-specific network information for said first printer from said port monitor.

6. The method of claim 1, wherein said printer-specific network information includes a TCP/IP address of said first printer and a MAC address of said first printer.

7. The method of claim 1, wherein said discovery packet is a propriety broadcast message to which only a printer of said designated type on said network will respond.

8. A computer program for automatically creating network printer ports on a computer workstation coupled to a network, said computer program including instructions for performing the steps of:
transmitting a discovery packet to which a printer of a designated type coupled to said network can respond;
receiving a response packet from said printer thereby identifying said printer as being of said designated type, said response packet including printer-specific network information of said printer;
identifying whether a network port exists on said computer workstation for said printer; and
if no such network port exists, then, creating a first network printer port for said printer based on said printer-specific network information for said printer.

9. The method of claim 8, wherein said printer-specific network information includes a TCP/IP address of said printer and a MAC address of said printer.

10. A method of automatically creating a network printer port on a workstation connected to a network, comprising the steps of:
providing a Windows operating system at said workstation, said Windows operating system including a print subsystem;
providing a Windows print spooler at said workstation having an Add Port mechanism;
providing a port monitor at said workstation;
invoking said Windows print spooler to initialize said port monitor; and
upon initialization of said port monitor, said port monitor sending a proprietary broadcast message to which each printer of a designated type on said network can respond, said each printer of said designated type responding to said proprietary broadcast message with a unique data packet including printer-specific network information;
said port monitor receiving said printer-specific network information; and
for each identified printer of said designated type for which no port exists, said port monitor invoking said Add Port mechanism of said Windows print spooler, and thereafter,
said port monitor passing said printer-specific network information to said Windows print spooler for creation of said network printer port on said workstation.

11. The method of claim 10, wherein said printer-specific network information includes at least one of a TCP/IP address and a MAC address.

12. The method of claim 10, wherein the step of invoking said Windows print spooler to initialize said port monitor occurs when said print subsystem is loaded by said workstation.
